(19) United States
(12) Patent Application Publication
(10) Pub. No.: US 2006/0276170 A1
(43) Pub. Date: Dec. 7, 2006

(54) Method and system for traffic redirection for prepaid subscriber sessions in a wireless network

(75) Inventors: Shaji E. Radhakrishnan, Nashua, NH (US); Kuntal Chowdhury, Plano, TX (US)

Correspondence Address: WILMER CUTLER PICKERING HALE AND DORR LLP, 60 STATE STREET, BOSTON, MA, 02109, US

(73) Assignee: Starent Networks Corporation, Tewksbury, MA (US)

(21) Appl. No.: 11/439,077

(22) Filed: May 23, 2006

Related U.S. Application Data
(60) Provisional application No. 60/683,580, filed on May 23, 2005.

(51) Int. Cl. H04M 11/00

(52) U.S. Cl. 455/405

(57) ABSTRACT

A method and system for redirecting communication traffic of a prepaid subscriber of a wireless network includes determining when the subscriber has exhausted or nearly exhausted his usage quota, identifying a recharging facility to which the subscriber should be redirected to recharge his account balance, and redirecting the subscriber communication traffic to the recharging facility as a result of determining that the subscriber has exhausted or nearly exhausted his usage quota. The redirection can occur during an existing session or during the process of initially establishing a session.

### CROSS REFERENCE TO RELATED APPLICATIONS

This application claims benefit of the following Patent Applications: U.S. Provisional Patent Application Ser. No. 60/683,580, filed May 23, 2005.

### FIELD OF INVENTION

The present invention relates to wireless communication services, and more particularly, to techniques for controlling prepaid user access to a wireless communications network.

### BACKGROUND OF INVENTION

Wireless communication systems and networks are used in connection with many applications, including, for example, satellite communications systems, portable digital assistants (PDAs), laptop computers, and portable communication devices (e.g., cellular telephones). One significant benefit that wireless communication networks provide to a user of such an application is the ability to connect, or stay connected to, a network (e.g., the Internet) as long as the user is within range of the wireless communication network.

Three major access techniques have been developed which are used to share the available bandwidth in a wireless communication system. Two of these techniques are referred to as time division multiple access (TDMA) and frequency division multiple access (FDMA). In TDMA systems, two or more signals (e.g., voice or data signals) share a single channel. In particular, in TDMA systems, multiple signals are transmitted over the same channel by allocating to the transmission of each signal a different time interval. In FDMA systems, on the other hand, the available frequency spectrum is divided into narrow channels, where each signal to be transmitted is assigned to a respective channel. The third technique, which is most relevant to the present invention, is referred to as code division multiple access (CDMA).

CDMA systems operate by dividing a radio spectrum to be shared by multiple users through the assignment of unique codes. CDMA systems assign a unique code to each signal that is to be transmitted, and are thereby able to spread many simultaneous signals across a wideband spread spectrum bandwidth. Using the respective codes, the signals can then be detected and isolated from the other signals that are being transmitted over the same bandwidth.

CDMA2000, the first third generation (3G) technology to be commercially deployed as part of the ITU's IMT-2000 framework, includes enhancements to the CDMA wireless cell phone technology that allow data to be transmitted in addition to voice. The TIA-835 standard defines architecture for prepaid service within a CDMA2000 system. Similar work is also ongoing in IETF. Prepaid packet data solution is being deployed in various operator networks at this time.

Each prepaid user of the CDMA2000 system has a prepaid account established on a pre-paid server (PPS), which defines how much service the user has available (i.e., through some previous purchase). A prepaid user can access the CDMA2000 wireless service if sufficient balance exists in his prepaid account. If during a wireless service session the balance falls to zero, or drops below some predetermined threshold, the wireless service session is terminated. In many cases, when the account balance is insufficient to complete the necessary setup process, the user cannot even successfully establish a wireless session.

This sort of session termination or prohibition has several drawbacks, such as a negative user experience and lost revenue for the system operators to name a few.

### SUMMARY OF INVENTION

In one aspect of the invention, a method of redirecting a session of a prepaid user includes determining when an account balance of the prepaid user falls below a predetermined threshold. The account balance indicates an amount of service for which the prepaid user is authorized. The method further includes redirecting the session to an application connected to an account recharging facility, when the account balance falls below the predetermined threshold. In one embodiment, the session of the prepaid user includes one or more discrete flows.

Another embodiment further includes notifying the prepaid user that the account balance has fallen below the predetermined threshold. In one embodiment, notifying the prepaid user includes providing a graphical interface that conveys information about the account balance. In another embodiment, notifying the prepaid user includes providing an audio interface that conveys information about the account balance.

One embodiment further includes providing the prepaid user with an interface for replenishing the account balance. Another embodiment includes restoring the session of the prepaid user from the redirection to the account recharging facility after the prepaid user has replenished the account balance.

In another aspect, a method of redirecting one or more flows of a session of a prepaid user includes determining when an account balance of the prepaid user falls below a predetermined threshold. The account balance indicates an amount of service for which the prepaid user is authorized. The method also includes redirecting at least one of the flows of the session to an account recharging facility when the account balance falls below the predetermined threshold.

In another aspect, a method of redirecting a one or more flows of a session of a user includes determining when an event has occurred for which the user is not authorized, redirecting at least one of the flows of the session to a server when the event has occurred, and providing a notification to the user that conveys information about the event. One embodiment further includes providing the user with an interface for correcting one or more conditions that caused the event. Another embodiment includes restoring the session of the user from the redirection to server after the user has corrected the one or more conditions that caused the event.

In another aspect, a system for redirecting a session of a prepaid user includes a prepaid client for representing the prepaid user, a prepaid server for maintaining an account balance of the prepaid user. The prepaid server also determines when the account balance falls below a predetermined threshold. The account balance indicates an amount of service for which the prepaid user is authorized. The system further includes an authentication server for receiving account balance information from the prepaid server, and for redirecting the session to an application connected to an account recharging facility when the account balance falls below the predetermined threshold. In one embodiment, the session of the prepaid user includes one or more discrete flows.

In one embodiment the account recharging facility notifies the prepaid client that the account balance has fallen below the predetermined threshold. In one embodiment, the account recharging facility provides a graphical interface to the prepaid client that conveys information about the account balance. In another embodiment, the account recharging facility provides an audio interface that conveys information about the account balance.

In one embodiment, the account recharging facility provides the prepaid user with an interface for replenishing the account balance. Another embodiment further includes restoring the session of the prepaid user from the redirection to the account recharging facility after the prepaid user has replenished the account balance.

Another aspect includes a system for redirecting a one or more flows of a session of a prepaid user. The system includes a prepaid client for representing the prepaid user, and a prepaid server for maintaining an account balance of the prepaid user. The prepaid server determines when the account balance falls below a predetermined threshold. The account balance indicates an amount of service for which the prepaid user is authorized. The system also includes an authentication server for receiving account balance information from the prepaid server, and for redirecting at least one of the flows to an application connected to an account recharging facility when the account balance falls below the predetermined threshold.

In another aspect, a system for redirecting one or more flows of a session of a user includes a client for representing the user, a server for maintaining a list of actions authorized for user. The server also determines when an action has occurred for which the user lacks authorization. The system further includes an authentication server for receiving the list of actions authorized for the user from the server. The authentication server redirects at least one of the flows to a resolution server when the action has occurred for which the user lacks authorization.

### BRIEF DESCRIPTION OF DRAWINGS

FIG. 1 shows a block diagram of a system for prepaid users suitable for use with at least one embodiment of the disclosed method and system for traffic redirection for prepaid subscriber sessions.

FIG. 2 illustrates a sequence of messages between system components for one embodiment in which redirection of an ongoing session for a prepaid user occurs.

FIG. 3 illustrates a sequence of messages between system components for one embodiment in which redirection of a new session for a prepaid user occurs.

FIG. 4 shows a sequence of messages between system components for one embodiment in which forced redirection for a prepaid user occurs.

### DETAILED DESCRIPTION

The method and system described herein allows a network operator to redirect a prepaid user's session, or individual flows within a session, to a web server (or some application that can either notify the user and/or can take further action on the user's session) for replenishing the user's account when the account falls below a predetermined limit, rather than terminating the session once the account is exhausted. The web server may be associated with a portal to a prepaid account recharging facility, or the server may be associated with an application that can help the user establish or maintain his packet date session.

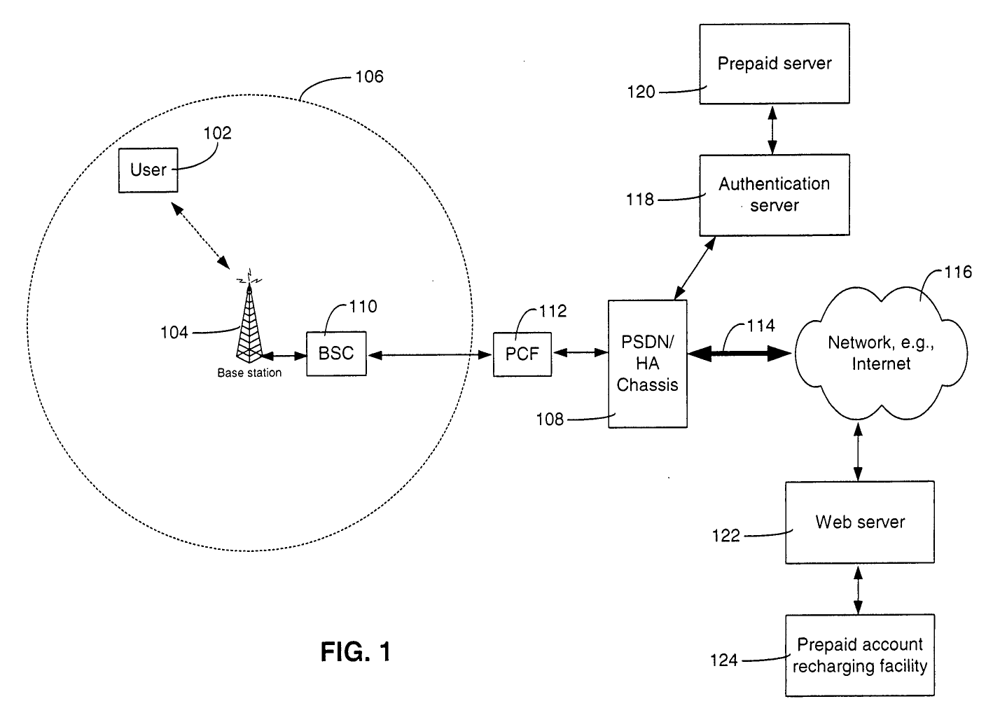

FIG. 1 shows a block diagram of a system for redirection of prepaid users suitable for use with at least one embodiment of the disclosed method and system for traffic redirection for prepaid subscriber sessions. As used herein, a session is one or more discrete call flows supported by the subscriber. The described embodiment uses CDMA2000 wireless network implementation, although other wireless networks may also be used. The CDMA2000 wireless network components set forth herein for the described embodiments are known in the art.

A prepaid wireless user 102 communicates with a base station 104 situated within a wireless network 106. The base station 104 communicates with a PDSN (packet data serving node) chassis 108 via a wire network. The wire network includes a base station controller 110 and a packet control function 112. The PSDN chassis communicates via a LAN 114 to other networks 116, thereby providing the prepaid wireless user 102 access to the other networks 116 (including the Internet), via the wireless network 106, the wire network 110, 112, and the PDSN chassis. The system also includes a RADIUS (Remote Authentication Dial-In User Service) authentication server 118 and a prepaid server 120 (PPS). The RADIUS server 118 authenticates user sessions via the wireless network 106, the wire network, and the PDSN chassis 108. The PPS 120 provides the system with prepaid account information via the RADIUS authentication server 118.

For 3GPP2 (www.3gpp2.org) standard based prepaid support, a PrePaid Client (PPC) receives quota and threshold information from the PPS 120 for a prepaid user session via the RADIUS authentication response. In this embodiment, the PPC is either the PDSN chassis 108 or the Home Agent chassis 108 shown in FIG. 1, representing the prepaid user 102 through the wireless network 106. The quota information defines how much service (in either volume based parameters or duration-based parameters) the prepaid user 102 is authorized to use, and the threshold information defines when additional quota should be requested. When the threshold is reached, the PPC 108 will request additional quota for the user session, by sending authentication requests to the PPS 120 via the RADIUS authentication server 118. If no additional quota is available and forthcoming, the user session would be disconnected in prior art systems. For many cases, system operators would prefer the prepaid user 102 to “recharge” his prepaid account online before or as soon as the complete quota is exhausted.

In order to facilitate such recharging in the described embodiment, the PPS 120 redirects the user's session, or individual flows within the session, to an application e.g. a web server 122 that operates in conjunction with a prepaid account replenishing facility, when the prepaid credit for the user runs out or falls below a preset limit. This redirection can be effected via any communication path available between the PPS 120 and the PPC 108. In one embodiment, the PPS 120 redirects the user's session by sending redirection information to PPC 108 in a RADIUS attribute that is included in the authentication response from the PPS 120 to the PPC 108. For example, the PPS 120 may include the redirection attribute in the initial Access Accept (authentication response in the RADIUS UDP packet message) to PPC 108 as part of establishing a session. As another example, the PPS may include the redirection RADIUS attribute during a session in any online Access Accept (i.e., prepaid quota update procedure).

In one embodiment, the RADIUS attribute contains information defining the redirection, such as the URL of the portal for the prepaid account recharging facility mentioned above, or the IP address and/or port of the application server associated with the portal.

In another embodiment, the RADIUS attribute contains an indication for prepaid redirection, which instructs the PPC 108 to use local policy information for redirection rules. In this case, the PPC 108 is configured to include redirection parameters (e.g., a RADIUS Filter-ID attribute), so that the RADIUS Filter-ID attribute is used to select the appropriate redirection rule.

When either the prepaid-redirection-information attribute or prepaid-redirection-indication attribute as described above are received in initial access accept or any online access accept, the PPC 108 must use the redirection information to redirect traffic from the prepaid user 102 when the quota is expired.

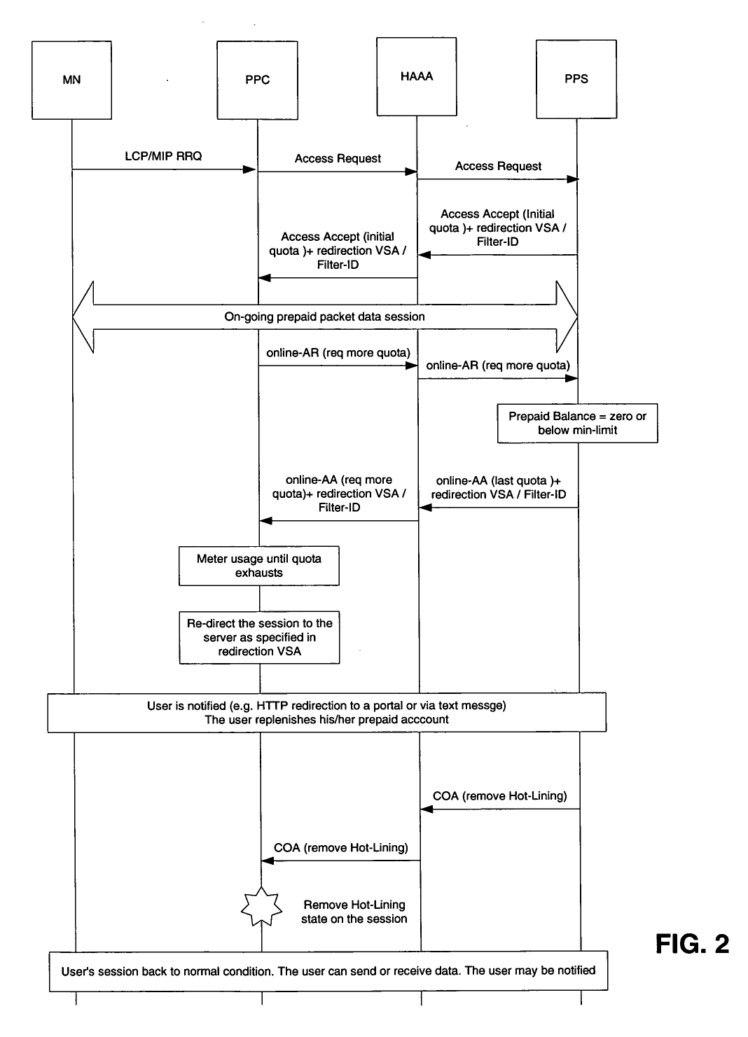

FIG. 2 illustrates a sequence of messages between system components for one embodiment in which redirection of an ongoing session for a prepaid user occurs. In FIGS. 2 through 4, the left-most block MN represents the mobile node, i.e., the prepaid user 102. The PPC block in these figures represents the prepaid client 108, as described above. The HAAA block represents the Home AAA (authentication, authorization, accounting) function (e.g., the RADIUS server 118). The PPS represents the prepaid server 120, as described above. The term “Hot-Lining” is used in this figure to indicate that when the session or individual flow within the session is redirected, it is also being blocked at the PPC 108. In some embodiments, hot-lining is not implemented, so that the session or individual flow is not blocked at the PPC 108 when the session on individual flow is redirected. In other embodiments, the session or individual flow may be blocked only based on policy decisions associated with the particular user.

FIG. 2 (among others) refers to a LCP/MIP RRQ message from the prepaid user to the PPC. LCP is Link Control Protocol used to setup a PPP link (Ref. RFC1661). MIP is Mobile IP Registration Request used to setup a Mobile IP connection between the mobile node and the home agent (Ref RFC 3344). FIG. 2 (among others) also refers to an online-AR message, which is a RADIUS message sent by the PPC to the prepaid server to update and/or request prepaid quota. FIG. 2 (among others) also refers to an online-AA message, which is a RADIUS message sent by the prepaid server to the PPC to assign prepaid quota. The COA message referred to in FIG. 2 (among others) is a RADIUS message sent by the prepaid server to the PPC to change the authorization status of the user's ongoing data session (Ref RFC 3576).

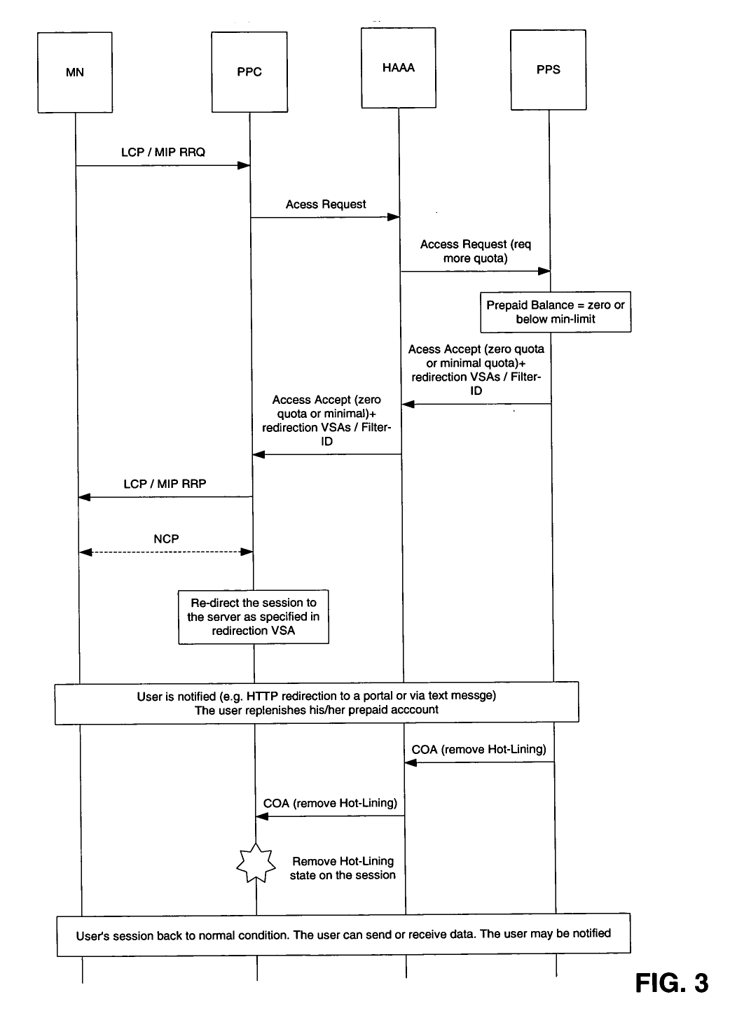

FIG. 3 illustrates a sequence of messages between system components for one embodiment in which redirection of a new session for a prepaid user occurs. In this scenario the user attempts to connect to the network while his prepaid account balance is zero or below a preset threshold. The PPS 120 sends a Redirection RADIUS attribute in the Access-Accept that contains either the URL of a portal or the IP address of an application e.g. a web server. In case of a reconfigured string in the PPC 108, the PPS 120 may also send the RADIUS Filter-ID attribute (as described above) to convey the filter to choose for this redirection.

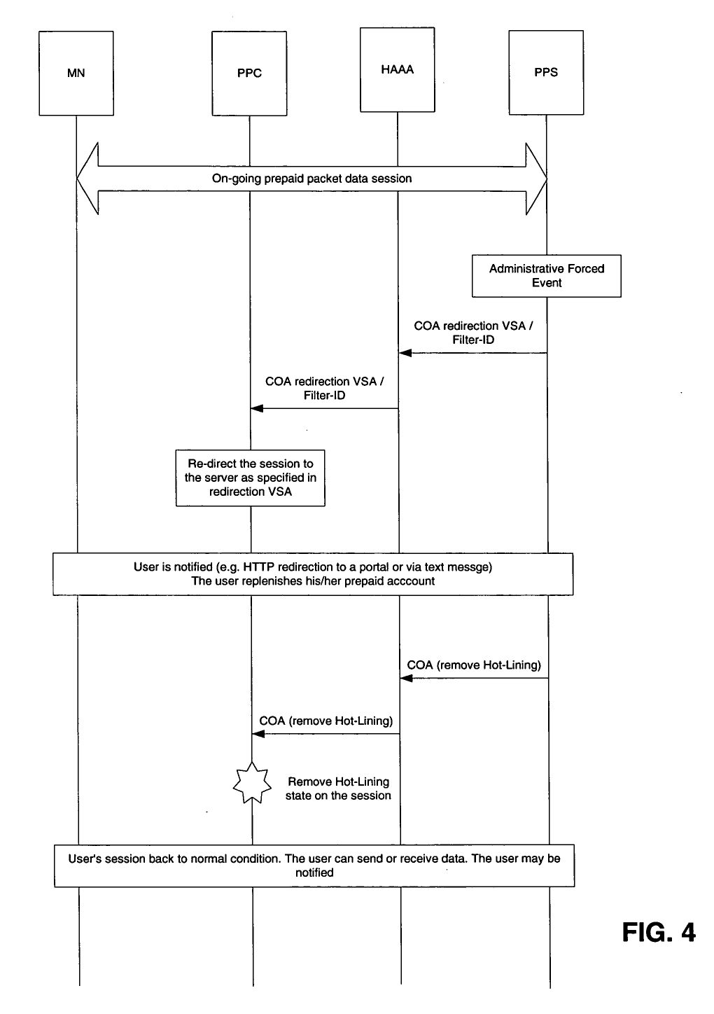

FIG. 4 shows a sequence of messages between system components for one embodiment in which forced redirection (by the system operator) for a prepaid user occurs. In this scenario the user has an ongoing prepaid session. The PPS 120 determines that the user's session needs to be redirected for any reason, e.g., administrative purpose, hitting tariff-switching boundary and the user's subscription is not valid for the new tariff, etc.

The concepts described herein may also be used for redirection of a session or flows within a session upon events other than an account balance falling below a limit. For example, other embodiments may redirect the session or individual flow within a session when the user performs an action for which the user does not have authorization. In such an embodiment, a server maintains a list of actions for which the user is authorized. For example, the user may only be authorized to access a particular set of network assets. Or, the user may only be authorized for a particular number of flows within a session. An authentication server uses this list of authorized actions, and monitors the session or individual flow within the session of the user to determine if the user performs an action that is not on the list of authorized actions. When the authentication server detects such an unauthorized action, the authentication server redirects the session or flows, as described above, to a resolution server for resolving the issue that caused the unauthorized action. Upon appropriate resolution of the issue, the authentication server may restore the session or flow to normal operation. The authentication server may also block the session or flow at the PPC, as described above.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method of redirecting a session of a prepaid user, comprising:
determining when an account balance of the prepaid user falls below a predetermined threshold, wherein the account balance indicates an amount of service for which the prepaid user is authorized;
redirecting the session to an application connected to an account recharging facility when the account balance falls below the predetermined threshold.

2. The method of claim 1, wherein the session of the prepaid user includes one or more discrete flows.

3. The method of claim 1, further including notifying the prepaid user that the account balance has fallen below the predetermined threshold.

4. The method of claim 3, wherein notifying the prepaid user includes providing a graphical interface that conveys information about the account balance.

5. The method of claim 3, wherein notifying the prepaid user includes providing an audio interface that conveys information about the account balance.

6. The method of claim 1, further including providing the prepaid user with an interface for replenishing the account balance.

7. The method of claim 1, further including restoring the session of the prepaid user from the redirection to the account recharging facility after the prepaid user has replenished the account balance.

8. A method of redirecting one or more flows of a session of a prepaid user, comprising:
determining when an account balance of the prepaid user falls below a predetermined threshold, wherein the account balance indicates an amount of service for which the prepaid user is authorized;
redirecting at least one of the flows of the session to an account recharging facility when the account balance falls below the predetermined threshold.

9. A method of redirecting one or more flows of a session of a user, comprising:
determining when an event has occurred for which the user is not authorized;
redirecting at least one of the flows of the session to a server when the event has occurred;
providing a notification to the user that conveys information about the event.

10. The method of claim 9, further including providing the user with an interface for correcting one or more conditions that caused the event.

11. The method of claim 10, further including restoring the session of the user from the redirection to server after the user has corrected the one or more conditions.

12. A system for redirecting a session of a prepaid user, comprising:
a prepaid client for representing the prepaid user;
a prepaid server for maintaining an account balance of the prepaid user, and for determining when the account balance falls below a predetermined threshold, wherein the account balance indicates an amount of service for which the prepaid user is authorized;
an authentication server for receiving account balance information from the prepaid server, and for redirecting the session to an application connected to an account recharging facility when the account balance falls below the predetermined threshold.

13. The system of claim 12, wherein the session of the prepaid user includes one or more discrete flows.

14. The system of claim 12, wherein the account recharging facility notifies the prepaid client that the account balance has fallen below the predetermined threshold.

15. The system of claim 14, wherein the account recharging facility provides a graphical interface to the prepaid client that conveys information about the account balance.

16. The system of claim 14, wherein the account recharging facility provides an audio interface that conveys information about the account balance.

17. The system of claim 12, wherein the account recharging facility provides the prepaid user with an interface for replenishing the account balance.

18. The system of claim 12, further including restoring the session of the prepaid user from the redirection to the account recharging facility after the prepaid user has replenished the account balance.

19. A system for redirecting one or more flows of a session of a prepaid user, comprising:
a prepaid client for representing the prepaid user;
a prepaid server for maintaining an account balance of the prepaid user, and for determining when the account balance falls below a predetermined threshold, wherein the account balance indicates an amount of service for which the prepaid user is authorized;
an authentication server for receiving account balance information from the prepaid server, and for redirecting at least one of the flows to an application connected to an account recharging facility when the account balance falls below the predetermined threshold.

20. A system for redirecting one or more flows of a session of a user, comprising:
a client for representing the user;
a server for maintaining a list of actions authorized for user, and for determining when an action has occurred for which the user lacks authorization;
an authentication server for receiving the list of actions authorized for the user from the server, and for redirecting at least one of the flows to a resolution server when the action has occurred for which the user lacks authorization.
